(19) United States
(12) Patent Application Publication
(10) Pub. No.: US 2006/0236058 A1
(43) Pub. Date: Oct. 19, 2006

(54) System for data collection and distribution

(76) Inventor: Goulven Jean Vernois, Arradon (FR)

Correspondence Address: Vernois Goulven, 8 Sentier des Laminaises, Arradon, 56610, FR

(21) Appl. No.: 10/560,249

(22) PCT Filed: Jun. 10, 2004
(86) PCT No.: PCT/FR04/01454

§ 371 Date: Feb. 27, 2006

(30) Foreign Application Priority Data
Jun. 13, 2003 (FR) 03/07104

(51) Int. Cl. G06F 12/00

(52) U.S. Cl. 711/170

(57) ABSTRACT

Slot-machine for collection and distribution of digital data including at least a local mass memory 6 and a local means of hiring of a memory capacity 13 of this mass memory 6. This means of hiring consists of a data reader 11, accessible on an outer side and reading the data of a data support 10, of an intermediate memory 11a, of a means 12 of analysis, comparison, refusal or acceptance of data 10, and of setting of the price of the hiring of memory capacity 13, and a means of payment authorizing the loading in mass memory of the data pending in the intermediate memory 11a.

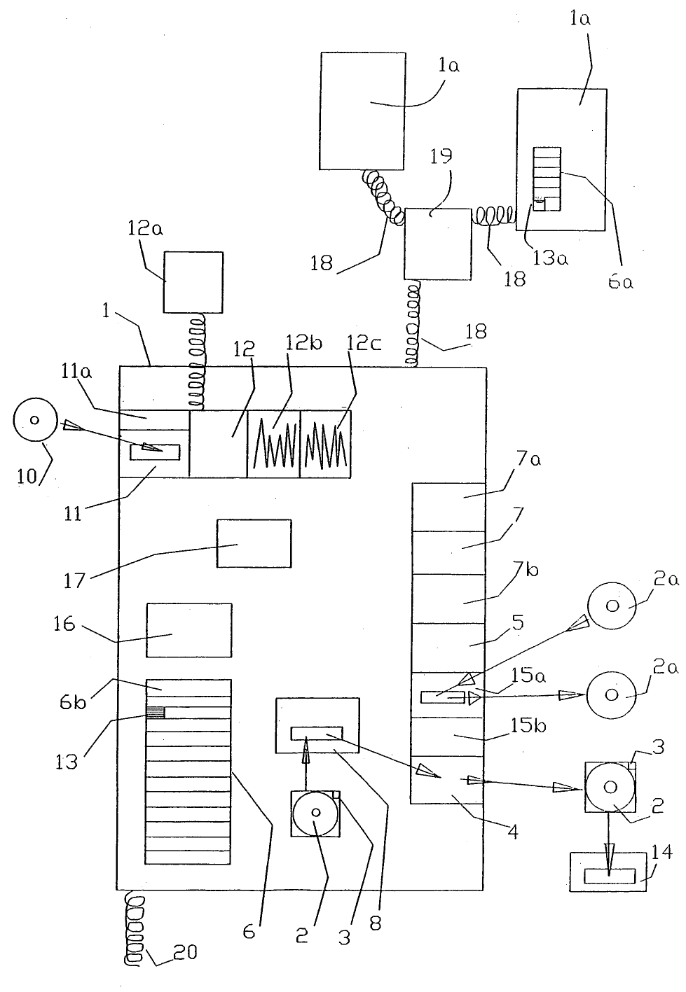

### FIELD OF THE INVENTION

The field of the invention is that of the collection and the distribution of the digital data, more particularly of the audio-visual digital data.

### FORMER STATE OF THE ART

The digital audio-visual data are diffused in the form of material supports legible in adapted readers, and in the form of files transmitted by the network internet.

The U.S. Pat. Nos. 5,633,839 A (ALEXANDER GREGORY et al.) of 27 May 1997, U.S. 5,949,688 A (FORKUM ALLAN et al.) of 07 Sep. 1999, U.S. 6,330,490 B1 (YANG JUN MO et al.) of Dec. 11 2001, CA 2 225 190 (R2M DISTRIB Inc) of Jun. 18, 1999, WO 01 52125 A (MARCONI TRADES SYSTEMS LTD) of 19 Jul. 2001, and OBVIOUS ABSTRACTS OF JAPAN of Oct. 31, 1998, describe means of distributing commercially data loaded to the request in a memory of disc type or electronics.

The means used are schematically represented by the single figure.

A material unit 1, having the characteristics of a slot-machine of the former art, contains a stock of virgin independant supports 2, for example optical discs CD/DVD with or without protective cartridgge, protected or not by electronic modules 3, a means of distribution 4 of these independent supports 2, and a means of payment 5 allowing it possible to obtain these independent loaded supports.

This material unit 1 also contains a means 6 of mass memory, for example hard disks, or optical discs.

The data stored on the mass memory 6 are loaded at the request of a means of choice 7 on the independent supports 2 by one or more means 8 of writing of these data, and a data processing means 9 determines the sum which must be provided by means of payment 5 to enter in possession of the independent support 2 loaded with the selected data.

### Response of the Invention to the Piracy Problem

The individual hacking being a cultural phenomenon as much as financial, refusal of a system of distribution seen at the internet age as obsolete, totalitarian and too expensive, it is not very probable that it can be fought successfully by technical means always got round, or by a repressive legislation, freedomkiller and probably unworkable.

The invention introduces a new fundamental aspect into the distributions of the data: the possibility for the producers of these data, or for the labels representing them, quasi automatically to charge these data on the mass memory of a slot-machine, at the price of the hiring of the memory capacity 13 of this mass memory occupied by these data loaded.

To allow this easy access of the producers to this means of diffusion, the means of mass storage of the slot-machine is fed partly or entirely from independent supports of data read by a suitable reading device.

This reading device makes an analysis of these data, accepts them or not, and determines the price of hiring of the memory capacity used in the said mass memory.

The invention cannot be opposed to the industrial piracy of data, but by improving considerably the relationship between supply and demand, it can satisfy legitimate waiting, as well of creators as of users, and put an end to a great part of this piracy.

### SUMMARY OF THE INVENTION

According to the invention, the mass memory 6 of the former art is fed by data contained onto independent supports 10, for example optical disks or floppy disks, introduced into a reader 11 in connection with said mass memory 6<<, or by data located on a distant data storage 6a connected by a suitable connection 18>>.

Reader 11 of these independent supports containing the data to be loaded on the mass memory 6 transmits these data to a local 12 or distant 12a, automatic or human, means of analysis, which decides acceptance or refusal of the data, and determines the amount of the hiring of memory capacity 13 used in the mass memory 6.

### BRIEF DESCRIPTION OF THE FIGURE

Single FIGURE: diagrammatic material overall picture of an autonomous slot-machine 1 of the former art, with the additions of the invention. The various connections between the elements are not represented. They are the connections of the former art of the electronic complex devices, for example of a computer which in general includes some of the elements of the autonomous slot-machine. In the same way, former art describes a very great number of devices of displacement and availability of objects by slot-machines, as well as means of payment accepting coins and bank cards with code.

### LIST ITEMS

1 and 1a—According to the invention—Automatic autonomous collector-distributor

2 and 2a—Former Art—Independent supports of data

3—Former art—Safety electronic modules

4—Former art—Means of availability of the independent supports 2

5—Former art—Means of payment

6 and 6a—Former art—Means of mass memory

6b—Former art—Directory of the means of mass memory

7—Former art—Means of choice of the data of the mass memory

7a—Former art—Means of visualization or listening of the selected data

7b—Former art—Means of manual selection of the selected data

8—Former art—Means of writing of the selected data onto an independent support

9 Former art—Means to determine the price to pay to obtain the independent support 2 loaded with the selected data

10—According to the invention—Independent support containing the data to be written on the mass memory 6

11—According to the invention—Reader of independent supports 10 containing the data to be written on the mass memory 6

11a—According to the invention—Memory to store temporaryly the data to be written on the mass memory 6

12 and 12a—According to the invention—Means of analysis of the data to be written on the mass memory 6

12b and 12c—According to the invention—Spectra of musical and lexical data to be compared

13—According to the invention—Memory capacity occupied by the data to be written on the mass memory 6

14—Former art—Independent reader

15a and 15 B—According to the invention—Means of checking and writing of the independent data supports 2a provided by a customer

16—According to the invention—Intermediate storage between the mass memory 6 and the means of writing 8 of the selected data

17—Former art—Means of internal management of the autonomous slot-machine 1

18—Former art—Means of connection between two or several autonomous slot-machines 1 and 1a

19—Former art—Means of management of a group of autonomous slot-machines 1 and 1a

20—Former art—Connection of the type “internet” or telephone, allowing the supply of the means of mass storage 6

### DESCRIPTION

The mass memory 6 of former art is fed, according to the invention, by the data contained on independent supports 10 being able to be read by a suitable reader 11.

These independent supports 10 can be, floppy disks, optical disks, hard disks, electronic memories or all other data supports.

This suitable reader 11 includes a means of temporary storage 11a in connection with a means of analysis local 12, or distant 12a, purely data-processing or with human component.

The data-processing component of the means of analysis 12 or 12a checks the nature of the data.

In the case of musical data, the means of analysis 12 or 12a does a spectrum 12b of musical notations, and a lexical analysis of the text possibly accompanying the music, per separated pieces, and compares this spectrum and this lexical analysis with the spectra and lexical analyses 12c contained in the mass memory and accompanying each unit of stored musical data.

If the data are not musical, or if the local means of analysis cannot provide an answer, they are either refused, or transferred to a human means.

The possible human component of the means of analysis 12 or 12a does an analysis “with the ear” of the musical data, a visual analysis of the data containing images, or a intellectual analysis of the purely data-processing data.

With the resulting one from this analysis, the data either are refused, or accepted, and in this case the means of analysis 12 or 12a fixes the price of the hiring of used memory capacity 13 of the mass memory.

According to the request accompanying the presentation of the data to be loaded on the mass memory, this loading can be done only on the only local mass memory 6, or on mass memory distant 6a, and the price of the hiring to be then calculated according to total memory capacity 13 and 13a used in various mass memory 6 and 6a.

The means of payment 5 of former art, or a means of payment dedicated 5a, authorize the loading of the data on the mass memory 6 or 6a that only after payment of the price of hiring determined by the means of analysis 12 or 12a.

The characteristic elements of the data loaded on the means of mass storage 6 and 6a are written on the catalogues 6b of these means of mass storage 6 and 6a.

According to the invention, a means 9 determines, in absolute value and expressed as a percentage, the royalty paid to the beneficiaries of the selected data.

The data loaded on the means of mass storage 6 or 6a can be directly accessible advertising data in auditive or visual form.

1) Autonomous data distributing-machine having at least:
a mass memory;
a means of selection of the data contained in the mass memory;
a means of loading the data selected on independent data supports;
characterized in that it has a reader directly accessible from outer, and dedicated to the reading of data supports brought by a creator, for example CD or DVD;

2) Autonomous data distributing-machine according to claim 1, characterized in that it has an intermediate memory in which will be charged temporarily the data read by the reader dedicated to the reading of the data support brought by a creator;

3) Autonomous data distributing-machine according to claim 1, characterized in that it has a means of analysis providing a musical and/or lexical spectrum of each audio-visual piece constituting the data brought by a creator, and read by the dedicated reader;

4) Autonomous data distributing-machine according to claim 1, characterized in that to each piece of audio-visual data existing in the mass memory is added its musical and/or lexical spectrum,

5) Autonomous data distributing-machine according to claim 1, characterized in that it has a means of comparison of the musical and/or lexical spectra allowing to the said autonomous data distributing-machine:
a) to compare an audio-visual piece brought by a creator with audio-visual pieces existing in mass memory,
b) to accept or refuse the pieces brought by the creator,

6) Autonomous data distributing-machine according to claim 1, characterized in that it has a means to fix the price of hiring of the memory capacity which will be occupied by the accepted audio-visual data, increased by their musical and/or lexical spectra, and on standby in the intermediate memory.

7) Autonomous data distributing-machine according to claim 1, characterized in that it has a specific means of payment authorizing the loading in the mass memory, of the data in standby in the intermediate memory, when the payment of the hiring is made.

8) Autonomous slot-machine of data according to claim 1, characterized in that the means of analysis of the data determines and displays, in absolute value and expressed as a percentage, the sums which will be versed to the creators and/or legal claimants of the data choosen by user.
